(19) United States
(12) Patent Application Publication
(10) Pub. No.: US 2016/0362586 A1
(43) Pub. Date: Dec. 15, 2016

(54) CONDUCTIVE FILM LAMINATE AND TOUCH PANEL USING THE SAME

(71) Applicant: FUJIFILM Corporation, Tokyo (JP)

(72) Inventors: Naoharu KIYOTO, Ashigara-kami-gun (JP); Yasuhiro MITAMURA, Ashigara-kami-gun (JP); Reiji HIGUCHI, Ashigara-kami-gun (JP); Yuuichi SHIRASAKI, Ashigara-kami-gun (JP)

(73) Assignee: FUJIFILM Corporation, Tokyo (JP)

(21) Appl. No.: 15/244,806

(22) Filed: Aug. 23, 2016

Related U.S. Application Data
(63) Continuation of application No. PCT/JP2015/053943, filed on Feb. 13, 2015.

(30) Foreign Application Priority Data
Mar. 28, 2014 (JP) 2014-070043

(51) Int. Cl. C09J 9/02; B32B 15/02; G06F 3/044; C09J 133/08; C09J 5/02; B32B 7/12; C09J 7/02

(52) U.S. Cl. CPC C09J 9/02; B32B 7/12; B32B 15/02; C09J 7/0296; C09J 7/0246; C09J 133/08; C09J 5/02; G06F 3/044; B32B 2307/202; B32B 2457/208; C09J 2467/006; G06F 2203/04112; G06F 2203/04103

(57) ABSTRACT

There is provided a conductive film laminate used in a touch panel, including: a first pressure sensitive adhesive layer; a first conductive layer; a substrate; a second conductive layer; and a second pressure sensitive adhesive layer, in this order, in which a total moisture content of the substrate, the first pressure sensitive adhesive layer, and the second pressure sensitive adhesive layer is 1.0 g/m² or less. There are provided a conductive film laminate, in which, even in a severe environment of high temperature and high humidity, a change of electrostatic capacitance between two layers of conductive films is small, high sensitivity can be maintained, and thus operation failure or malfunction can be prevented, and a touch panel using this conductive film laminate.

### CROSS REFERENCE TO RELATED APPLICATIONS

This application is a continuation application of International Application No. PCT/JP2015/053943 filed on Feb. 13, 2015, which claims priority under 35 U.S.C. 119(a) to Application No. 2014-070043 filed in Japan on Mar. 28, 2014, all of which are hereby expressly incorporated by reference into the present application.

### BACKGROUND OF THE INVENTION

### 1. Field of the Invention

The present invention relates to a conductive film laminate and a touch panel using this and specifically relates to a conductive film laminate having conductive films on both sides of a substrate and pressure sensitive adhesive layers respectively on the external sides of both of the conductive films and being used in a touch panel and an electrostatic capacitance touch panel using this.

### 2. Description of the Related Art

Recently, with respect to a liquid crystal display (LCD), a touch panel display, an electronic paper, and the like, there has been used an electrostatic capacitance-type touch panel sensor using a conductive film laminate that enables the use of an information terminal device such as a touch panel even in a high temperature and high humidity environment by preventing resistance increase of a conductive film, greatly suppressing a rate of increase in resistance value of the conductive film, suppressing deterioration of the conductive film, and preventing the operation failure of the touch panel, so as to remove a cause of failure of an information terminal device, even in a high temperature and high humidity environment (for example, see JP2013-198990A and JP2011-132522A).

JP2013-198990A relating to the application of the present applicant discloses a conductive film laminate having a substrate, conductive films respectively on both sides of the substrate, and pressure sensitive adhesive layers respectively on both sides of the external side of the conductive films, that is, a conductive film laminate having a substrate, a pattern conductive film (first conductive film) consisting of metal nanowires formed on one surface side of the substrate, a pressure sensitive adhesive layer (first pressure sensitive adhesive film) formed so as to cover this pattern conductive film, a conductive film (second conductive film) consisting of metal nanowires formed on the other surface side of the substrate, and a pressure sensitive adhesive layer (second pressure sensitive adhesive film) formed so as to cover this second conductive film. In this conductive film laminate, it is possible to prevent resistance increase of the pattern transparent conductive film and prevent operation failure of the touch panel in a high temperature and high humidity environment by constituting the substrate as a support and a barrier film, supporting the pattern conductive film with the support via the barrier film, covering an external side surface of the first pressure sensitive adhesive film and an external side surface of the second pressure sensitive adhesive film with a cover film comprising the barrier film and the substrate, and preventing the infiltration of moisture from the substrate or the external portion to the pattern conductive film.

JP2011-132522A discloses an electrostatic capacitance-type touch panel that in which a laminate having a glass substrate, an ITO transparent conductive film or the like formed on one surface of this glass substrate, a pressure sensitive adhesive layer (first pressure sensitive adhesive layer) formed so as to cover this conductive film, and a pressure sensitive adhesive layer (second pressure sensitive adhesive layer) formed on one side of the glass substrate is used, the conductive film and the display device are fixed to each other by the first pressure sensitive adhesive layer of the laminate, and the resin film layer is fixed thereto by the second pressure sensitive adhesive layer.

JP2011-132522A discloses that, in a case of an electrostatic capacitance-type touch panel, in order to realize high precision of the position detection, a first pressure sensitive adhesive layer for fixing a conductive film and a display device to each other requires a performance in which electrical capacitance (electrostatic capacitance) of the conductive film does not change.

Therefore, in the touch panel disclosed in JP2011-132522A, an electrical resistance value increasing rate of a conductive film to which a pressure sensitive adhesive sheet adheres even at a high temperature and high humidity can be suppressed to 10% or less, without depending on types of pressure sensitive adhesives, by causing the moisture content of the pressure sensitive adhesive of a first pressure sensitive adhesive layer formed from a pressure sensitive adhesive sheet for adhering the conductive film to be 0.2% or less, so as to prevent malfunction or the like of an information terminal device such as a touch panel, in a high temperature and high humidity environment.

### SUMMARY OF THE INVENTION

However, in the conductive film laminate disclosed in JP2013- 98990A, since barrier films are provided between the substrate and the pattern conductive films, on the external side surface of the first pressure sensitive adhesive film that covers the pattern conductive film, and the external side surface of the second pressure sensitive adhesive film that covers the second conductive film formed on the other surface side of the substrate in order to prevent infiltration of moisture from a substrate or an external portion to a pattern conductive film even in a high temperature and high humidity environment, there is a problem that the thickness becomes thick.

Even if infiltration of moisture from an external portion is prevented by providing barrier films at three positions, infiltration of moisture from the substrate to the second conductive film cannot be prevented, resistance increase in the pattern transparent conductive film in a high temperature and high humidity environment may not be able to be prevented according to the moisture amount included in the entirety of the substrate, the first pressure sensitive adhesive film, and the second pressure sensitive adhesive film, that is, the total moisture content, the change in the electrostatic capacitance between the pattern transparent conductive films becomes great, and thus there is a problem that there is a concern that the stability of the operation of the touch panel may be lost.

In JP2011-132522A, the conductive film is provided on only one side of the glass substrate in the ITO transparent conductive film or the like, and the moisture content of the first pressure sensitive adhesive layer that fixes the conductive film and the display device to each other is set to be 0.2% or less. However, since the moisture content of the substrate in which the conductive film is formed is not considered at all, according to the moisture amount included in the entirety of the substrate and the first pressure sensitive adhesive layer, that is, the total moisture content, an electrical resistance value increasing rate of the conductive film in a high temperature and high humidity environment may not be able to be suppressed, the change of the electrostatic capacitance of the conductive film becomes great, and thus there is a problem that there is concern in that stability of an operation of the electrostatic capacitance-type touch panel may be lost.

An object of the invention is to solve the problems described above in the related art and to provide a conductive film laminate that can prevent operation failure or malfunction in which change in electrostatic capacitance between two layers of conductive films is small even in a severe environment of high temperature and high humidity and a touch panel using this.

In order to achieve the objects described above, there is provided a conductive film laminate according to the invention used in a touch panel, comprising: a first pressure sensitive adhesive layer; a first conductive layer; a substrate; a second conductive layer; and a second pressure sensitive adhesive layer, in this order, in which a total moisture content of the substrate, the first pressure sensitive adhesive layer, and the second pressure sensitive adhesive layer is 1.0 g/m² or less.

Here, a moisture content of the substrate is preferably less than a total moisture content of the first pressure sensitive adhesive layer and the second pressure sensitive adhesive layer.

A moisture content of the substrate is preferably 0.06 g/m² or less.

A total moisture content of the first pressure sensitive adhesive layer and the second pressure sensitive adhesive layer is preferably 0.53 g/m² or less.

A thickness of the substrate is preferably 50 μm or less.

In-plane retardation of the substrate at a wavelength of 550 nm is preferably 200 nm or less.

The substrate is preferably a 214 wavelength plate.

It is preferable to form a conductive film in which the first conductive layer, the substrate, and the second conductive layer are arranged in this order.

The first conductive layer and the second conductive layer preferably are constituted by mesh-shaped metal thin wires.

A touch panel according to the invention uses the conductive film laminate described above.

Here, this touch panel is preferably an electrostatic capacitance-type touch panel.

According to the invention, even in a severe environment of high temperature and high humidity, a change of electrostatic capacitance between two layers of conductive films is small, and operation failure or malfunction can be prevented.

### BRIEF DESCRIPTION OF THE DRAWINGS

FIG. 1 is a cross-sectional view schematically illustrating a conductive film laminate according to an embodiment of the invention.

FIG. 2 is a cross-sectional view of an embodiment of a touch panel using a conductive film laminate illustrated in FIG. 1.

FIG. 3 is a plan view schematically illustrating the entire constitution of a touch panel sensor of the conductive film laminate illustrated in FIG. 1.

FIGS. 4A and 4B are enlarged plan views schematically illustrating parts of a first detection electrode and a second detection electrode of the touch panel sensor illustrated in FIG. 3, respectively.

FIG. 5 is a graph illustrating a relationship between the number of elapsed days and electrostatic capacitance values of examples and comparative examples according to the invention.

FIG. 6 is a graph illustrating a relationship between the number of elapsed days and change ratios of electrostatic capacitance values of the examples and the comparative examples according to the invention.

FIG. 7 is a graph illustrating a relationship between total moisture contents and the change ratios of the electrostatic capacitance values according to the examples and the comparative examples according to the invention.

FIG. 8 is a graph illustrating a relationship between moisture contents of pressure sensitive adhesive layers and the change ratios of the electrostatic capacitance values of the examples and the comparative examples of the invention.

FIG. 9 is a graph illustrating a relationship between moisture contents of the substrates and the change ratios of the electrostatic capacitance values according to the examples and the comparative examples according to the invention.

### DESCRIPTION OF THE PREFERRED EMBODIMENTS

A conductive film laminate according to the invention and a touch panel using this are specifically described below based on preferred embodiments shown in the accompanying drawings.

Hereinafter, the touch panel according to the invention is described with an electrostatic capacitance-type touch panel as a representative example, and the conductive film laminate according to the invention is described with a conductive film laminate used in an electrostatic capacitance-type touch panel sensor as a representative example. However, the invention is not limited to these and may be any types. For example, the invention may be various types of touch panels or may be ones used as touch panel sensors of touch panels in various types like this.

In this specification, the numerical values described by using the expression “to” mean a scope including numerical values described before and after the expression “to” as a lower limit and an upper limit.

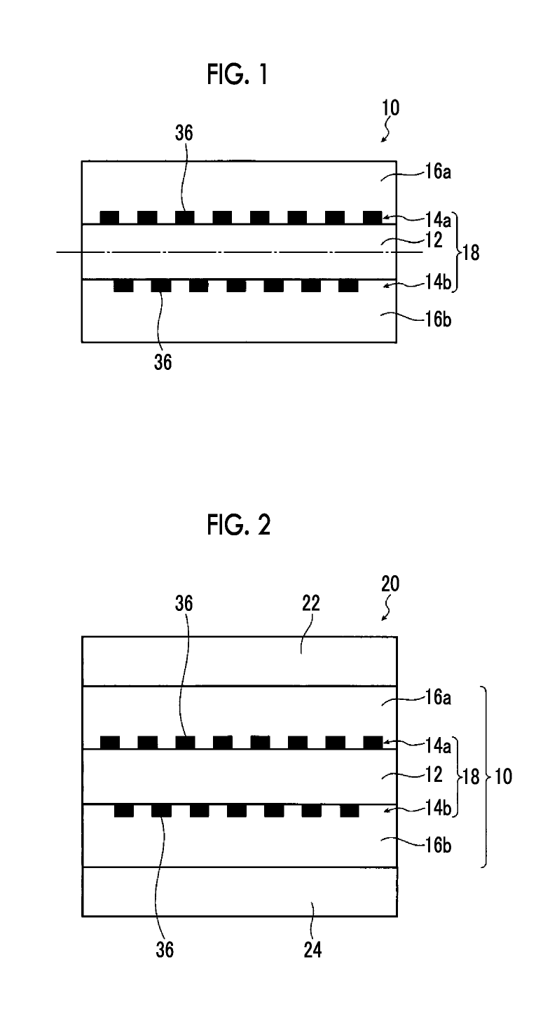

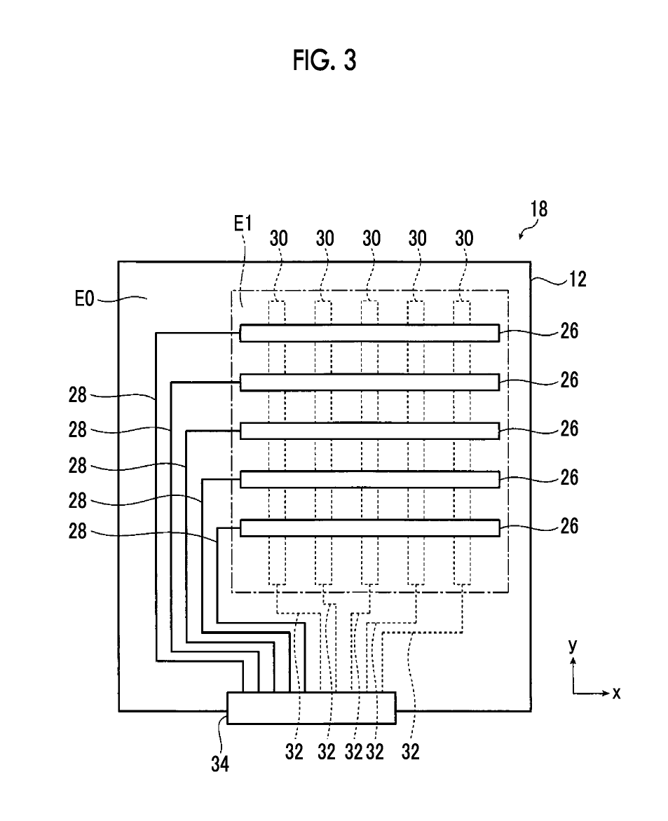

FIG. 1 is a cross-sectional view of an example of a conductive film laminate according to the embodiment of the invention. FIG. 2 is a cross-sectional view of an example of a touch panel according to the invention which uses the conductive film laminate illustrated in FIG. 1. FIG. 3 is a plan view schematically illustrating an example of the entire constitution of the conductive film laminate illustrated in FIG. 1.

A conductive film laminate 10 of an embodiment illustrated in FIG. 1 is used as a touch panel sensor. As illustrated in FIG. 1, the conductive film laminate 10 has a substrate 12, a first conductive layer 14a formed on a main surface of the substrate 12 on one side, a first pressure sensitive adhesive layer 16a formed so as to cover this first conductive layer 14a, a second conductive layer 14b formed on a main surface of the substrate 12 on the other side, and a second pressure sensitive adhesive layer 16b formed to cover this second conductive layer 14b.

That is, the conductive film laminate 10 according to the embodiment has the first pressure sensitive adhesive layer 16a, the first conductive layer 14a, the substrate 12, the second conductive layer 14b, and the second pressure sensitive adhesive layer 16b, in this order. The first conductive layer 14a, the substrate 12, and the second conductive layer 14b constitute a conductive film and functions as a touch panel sensor 18.

Though details are described below, in the conductive film laminate 10 according to the embodiment, even in a high temperature and high humidity environment, in order to reduce the change of electrostatic capacitance of the conductive film laminate 10, particularly, the change of electrostatic capacitance between the first conductive layer 14a and the second conductive layer 14b, a total moisture content of three layers of the substrate 12, the first pressure sensitive adhesive layer 16a, and the second pressure sensitive adhesive layer 16b is required to be 1.0 g/m² or less.

If moisture exists in these three layers, permittivity of water is extremely high as 80.4 (20° C.). Therefore, it is considered that average permittivity between the electrodes (between the first and second conductive layers 14a and 14b) increases, such that electrostatic capacitance increases. Therefore, according to the invention, the total moisture content of these three layers is limited to 1.0 g/m² or less.

According to the invention, the “moisture content” refers to an amount (g/moisture obtained by measuring a moisture content in a measurement sample such as the substrate or the conductive layer under the conditions of the temperature of 25° C. and the humidity of 90% and converting the moisture content by the thickness. Specific measuring methods are described below.

A touch panel 20 according to the embodiment illustrated in FIG. 2 is used as an electrostatic capacitance-type touch panel. As illustrated in FIG. 2, this touch panel 20 has the conductive film laminate 10, a protective substrate 22 arranged on the external side surface of the first pressure sensitive adhesive layer 16a of the conductive film laminate 10, and a display device 24 arranged on the external side surface of the second pressure sensitive adhesive layer 16b of the conductive film laminate 10.

(Substrate)

The substrate 12 has electrical insulating properties, supports the first conductive layer 14a arranged on one surface in a layer shape, supports the second conductive layer 14b arranged on the other surface in a layer shape, and performs electrical insulation between the first conductive layer 14a and the second conductive layer 14b.

The substrate 12 preferably transmits light appropriately and specifically the substrate 12 preferably has total light transmittance from 85% to 100%.

The substrate 12 is preferably a transparent insulating substrate, and examples thereof include a transparent insulating resin substrate, a transparent ceramics substrate, and a transparent glass substrate. Among these, the transparent insulating resin substrate is preferable since the substrate has excellent flexible properties, can be easily handled, and can be caused to be thin.

Specific examples of the material for constituting the transparent insulating resin substrate include polyethylene terephthalate, polyethersulfone, a polyacrylic resin, a polyurethane-based resin, polyester, polycarbonate, polysulfone, polyamide, polyarylate, polyolefin, a cellulose-based resin, polyvinyl chloride, and a cycloolefin-based resin. Among these, for the reason of excellent transparency, polyethylene terephthalate, a cycloolefin-based resin, polycarbonate, and a triacetyl cellulose resin are preferable.

The moisture content of the substrate 12 may be any amount, as long as the total moisture content described above satisfies the range described above. However, the moisture content is preferably small. For example, the moisture content is preferably 0.06 g/m² or less and more preferably 0.01 g/m² or less.

The reason is that the total moisture content described above satisfies the range described above, if the moisture content of the substrate 12 is small, for example, 0.06 g/m² or less and that the change of the electrostatic capacitance of the conductive film laminate 10 according to the invention can be reduced even in a high temperature and high humidity environment.

The substrate 12 may be a single layer or may be a multiple layer of two or more layers. The thickness of the substrate 12 is not particularly limited. For example, the thickness thereof is preferably 50 μm or less. The lower limit of the thickness of the substrate 12 is not particularly limited, and may be any thickness, as long as the first conductive layer 14a and the second conductive layer 14b can be supported, and electrical insulation can be performed between the first conductive layer 14a and the second conductive layer 14b. The lower limit thereof is preferably 25 μm or greater.

If the thickness of the substrate 12 is in the range described above, desired transmittance of the visible light can be obtained, handling is easy, and thinning can be achieved, such that the moisture content of the substrate 12 can be suppressed to be low, and retardation described below can be suppressed to be low. If the thickness of the substrate 12 is caused to be thin, electrostatic capacitance increases, and sensitivity (a change ratio of the electrostatic capacitance) decreases, and thus it is not preferable.

The plan view shape of the substrate 12 is not particularly limited. For example, the plan view shape may be a rectangular shape (an oblong shape: see FIG. 3), a square shape, a polygonal shape, a circular shape, and an elliptical shape.

The substrate 12 preferably has low retardation. Specifically, the in-plane retardation of the substrate 12 at the wavelength of 550 nm is preferably 200 nm or less.

The in-plane retardation of the substrate 12 can be measured by well-known low retardation measuring methods and devices using polarization measuring modules using polarizing elements and transmissive polarization optical systems consisting of polarization plates and λ/4 plates. Specifically, the “in-plane retardation in the wavelength of 550 nm” is measured by causing light having a wavelength of 550 nm to be incident in the film normal direction, for example, by KOBRA 21ADH or KOBRA WR (all are manufactured by Oji Scientific Instruments). With respect to the selection of measurement wavelength of 550 nm, measurement can be performed by manually changing a wavelength selection filter or by converting a measurement value with a program or the like.

If the retardation of the substrate 12 is in the range described above, the generation of rainbow unevenness can be suppressed, and the visibility of the display screen of the display device 24 of the touch panel 20 can be caused to be satisfactory.

In order to prevent black-out of the display screen of the display device 24 of the touch panel 20, the substrate 12 is preferably a ¼ wavelength phase difference plate that generates phase difference for approximately ¼ wavelengths, a so-called a λ/4 wavelength plate. If the substrate 12 is a λ/4 wavelength plate of reciprocal wavelength dispersion in which an absolute value of the phase difference becomes high as the wavelength becomes long, tint becomes neutral and thus it is more preferable.

(First and second conductive layers)

The first conductive layer 14a and the second conductive layer 14b together with the substrate 12 interposed therebetween constitute the electrostatic capacitance-type touch panel sensor 18.

The electrostatic capacitance-type touch panel sensor 18 is a sensor that is arranged on the display device 24 (on an operator side) in the touch panel 20 and detects a position of an external portion conductor such as a finger of a human being, by using the change of electrostatic capacitance generated when an external portion conductor such as a finger of a human being is brought into contact with (comes close to) the protective substrate 22.

The electrostatic capacitance-type touch panel sensor 18 has detection electrodes substantially orthogonal to each other (for example, detection electrodes extending in the X direction and detection electrodes extending in the Y direction) and specifies coordinates of the finger by detecting an electrostatic capacitance change of the detection electrode which the finger is brought into contact with or come close to.

Specifically, as illustrated in FIG. 3, the electrostatic capacitance-type touch panel sensor 18 comprises the substrate 12, first detection electrodes 26 and first lead-out wiring 28 which are formed on the first conductive layer 14a arranged on the main surface (on the surface) of the substrate 12 on one surface, second detection electrodes 30 and second lead-out wiring 32 formed on the second conductive layer 14b arranged on the main surface (on the back surface) of the substrate 12 on the other side, and a flexible printed wiring board 34. An area in which the first detection electrodes 26 and the second detection electrodes 30 are present constitutes an input area E1 (an input area at which a contact of an object can be detected (a sensing portion)) in which an input operation by a user (an operator) is possible, and, in an external side area EU positioned on the external side of the input area E1, the first lead-out wiring 28, the second lead-out wiring 32, and the flexible printed wiring board 34 are arranged.

The first detection electrodes 26 and the second detection electrodes 30 are sensing electrodes that sense the change of the electrostatic capacitance, and constitute a sensing portion (a sensor portion). That is, if a finger tip is brought into contact with the touch panel, mutual electrostatic capacitance between the first detection electrodes 26 and the second detection electrodes 30 changes, and the position of the finger tip is calculated by an IC circuit based on an amount of this change.

The first detection electrodes 26 have a role of detecting an input position of the finger of the user that comes close to the input area E1 in the X direction and has a function of generating electrostatic capacitance between the first detection electrodes 26 and the finger. The first detection electrodes 26 are electrodes that extend in the first direction (X direction) and that are arranged having a predetermined interval in the second direction (Y direction) that intersects with the first direction and include a predetermined pattern as described below.

The second detection electrodes 30 have a role of detecting an input position of the finger of the user that comes close to the input area E1 in the Y direction and has a function of generating electrostatic capacitance between the second detection electrodes 30 and the finger. The second detection electrodes 30 are electrodes that extend in the second direction (Y direction) and that are arranged having a predetermined interval in the first direction (X direction) and include a predetermined pattern as described below. In FIG. 3, five of the first detection electrodes 26 and five of the second detection electrodes 30 are provided, but the numbers thereof are not particularly limited, and there may be plural detection electrodes.

As illustrated in FIG. 1, the first detection electrodes 26 and the second detection electrodes 30 illustrated in FIG. 3 are constituted by conductive thin wire 36 arranged on the first conductive layer 14a and the second conductive layer 14b in a layer shape.

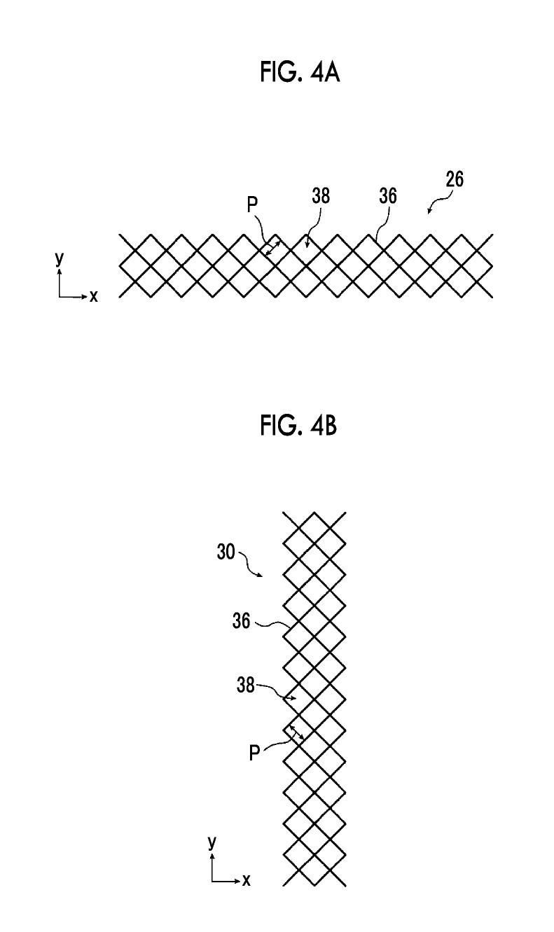

FIGS. 4A and 4B illustrate enlarged plan views of portions of the first detection electrodes 26 and the second detection electrodes 30, respectively. As illustrated in FIG. 4A, the first detection electrodes 26 are constituted by the conductive thin wire 36 in a mesh shape, have a wiring pattern including plural lattices 38 by the intersecting conductive thin wire 36, and extend in the X direction (in the horizontal direction in FIGS. 4A and 4B) in a belt shape. Meanwhile, as illustrated in FIG. 4B, in the same manner as the first detection electrodes 26, the second detection electrodes 30 are constituted by the conductive thin wire 36 in a mesh shape and have a wiring pattern including the plural lattices 38 by the intersecting conductive thin wire 36, but differently from the first detection electrodes 26, extend in the Y direction (in the vertical direction in FIGS. 4A and 4B) in a belt shape.

Examples of the material of the conductive thin wire 36 include metal or an alloy such as gold (Au), silver (Ag), copper (Cu), aluminum (Al), and metal oxide such as ITO, tin oxide, zinc oxide, cadmium oxide, gallium oxide, and titanium oxide. Among these, since conductivity of the conductive thin wire 36 is excellent, silver is preferable.

In view of adhesiveness of the conductive thin wire 36 and the substrate 12, the conductive thin wire 36 preferably includes a binder.

Since adhesion between the conductive thin wire 36 and the substrate 12 is excellent, the binder is preferably a water soluble polymer. Examples of the types of the binder include gelatin carrageenan, polyvinyl alcohol (PVA), polyvinylpyrrolidone (PVP), polysaccharides such as starch, cellulose and derivatives thereof, polyethylene oxide, polyvinylamine, chitosan, polylysine, polyacrylic acid, polyalginic acid, polyhyaluronic acid, carboxy cellulose, gum arabic, and sodium alginate. Among these, since adhesion between the conductive thin wire 36 and the substrate 12 is excellent, gelatin is preferable.

As gelatin, in addition to lime-treated gelatin, acid-treated gelatin may be used, and hydrolysate of gelatin, a gelatin enzyme decomposition product, other amino groups, and gelatin (phthalated gelatin and acetylated gelatin) modified by carboxylic acid can be used.

As the binder, a polymer (hereinafter, simply referred o as a polymer) different from the gelatin may be used together with gelatin.

The types of the polymer used is not particularly limited, as long as the polymer is different from gelatin, but examples thereof include at least some of resins selected from the group consisting of an acrylic resin, a styrene-based resin, a vinyl-based resin, a polyolefin-based resin, a polyester-based resin, a polyurethane-based resin, a polyamide-based resin, a polycarbonate-based resin, a polydiene-based resin, an epoxy-based resin, a silicone-based resin, cellulose-based polymer, and a chitosan-based polymer, and a copolymer consisting of a monomer constituting these resins.

A volume ratio (volume of metal/volume of binder) of the metal and the binder in the conductive thin wire 36 is preferably 1.0 or greater and even more preferably 1.5 or greater. If the volume ratio of the metal and the binder is caused to be 1.0 or greater, conductivity of the conductive thin wire 36 can be increased. The upper limit is not particularly limited, but, in view of productivity, the upper limit is preferably 6.0 or less, more preferably 4.0 or less, and even more preferably 2.5 or less.

The volume ratio of the metal and the binder can be calculated from the density of the metal and the binder included in the conductive thin wire 36. For example, in a case where the metal is silver, the volume ratio is calculated by setting the density of silver to be 10.5 g/cm³, and in a case where a binder is gelatin, the volume ratio is calculated by setting the density of gelatin to be 1.34 g/cm³.

The line width of the conductive thin wire 36 is not particularly limited. However, since the low resistance electrode can be formed more easily, the line width is preferably 30 μm or less, more preferably 15 μm, even more preferably 10 μm, particularly preferably 9 μm or less, and most preferably 7 μm or less, and the line width is preferably 0.5 μm or greater and more preferably 1.0 μm or greater.

The thickness of the conductive thin wire 36 is not particularly limited. However, in view of conductivity and visibility, the thickness can be selected from 0.00001 mm to 0.2 mm, but the thickness is preferably 30 μm or less, more preferably 20 μm or less, even more preferably 0.01 to 9 μm, and most preferably 0.05 to 5 μm.

The lattices 38 of the conductive thin wire 36 formed as a wiring pattern of the first and second detection electrodes 26 and 28 in a mesh shape include an opening area surrounded by the conductive thin wire 36. The length of one side of the lattices 38, that is, a pitch P is preferably 800 μm or less, more preferably 600 μm or less, and the length is preferably 50 μm or greater.

In the first detection electrodes 26 and the second detection electrodes 30, in view of visible light transmittance, an opening ratio is preferably 85% or greater, more preferably 90% or greater, and most preferably 95% or greater. The opening ratio corresponds to a ratio occupied by a transmissive portion in the first detection electrodes 26 or the second detection electrodes 30 except for the conductive thin wire 36 in the predetermined area.

In the illustrated example, the lattices 38 have a substantially rhombus shape. In addition, according to the invention, the shape of the lattices 38 is not limited, and the shape of the lattices 38 may be another polygonal shape (for example, a triangle shape, a quadrilateral shape, a hexagonal shape, a rhombus shape, or a random polygonal shape). A shape of one side may be a curve or an arc, in addition to a straight line shape. In the case of an arc shape, with respect to facing two sides, an external one is set to have a convex arc shape, and with respect to facing two sides, an internal one is set to have a convex arc shape. The shape of the respective sides may be a wave line shape in which externally convex arcs and internally convex arcs are continued. Of course, the shape of the respective sides may be a sine curve or a cosine curve. The shape of the lattices 38 may be a completely random shape (irregular shape). In a case where a lattice shape is a regular polygonal shape, the length of the side may be the pitch P. In a case where the lattice shape is not a regular polygonal shape, a distance between the centers of the adjacent lattices is set to be a pitch. In the case of the random lattice shape, the pitch is measured, for example, with 30 lattices, and an average value thereof is set to be a pitch.

In FIGS. 4A and 4B, the conductive thin wire 36 is formed with a mesh pattern, but the embodiment is not particularly limited and may be a stripe pattern.

In the illustrated example, the first detection electrodes 26 and the second detection electrodes 30 have the same wiring pattern. However, the invention is not limited thereto, and both may be different shapes. For example, both shapes of the lattices 38 may be different, the pitchs P of the lattices 38 may be different, or line widths of the conductive thin wire 36 constituting e lattices 38 may be different. The both may have the different conductive thin wire 36 for constituting the lattices 38.

The conductive thin wire 36 of the first detection electrodes 26 and the second detection electrodes 30 may be constituted with metal oxide particles or a metal paste such as a silver paste or a copper paste. Among these, in view of excellent conductivity and transparency, a conductive film due to silver thin wire is preferable.

The description has made with reference to the example in which the first detection electrodes 26 and the second detection electrodes 30 are constituted in a mesh structure of the conductive thin wire 36. However, the invention is not limited to this embodiment, and the first detection electrodes 26 and the second detection electrodes 30 may be formed with, for example, metal oxide thin films (transparent metal oxide thin films) such as ITO and ZnO thin films or transparent conductive films that constitute a network with metal nanowires such as silver nanowires or copper nanowires.

The first lead-out wiring 28 and the second lead-out wiring 32 are members carrying out a role for applying a voltage respectively to the first detection electrodes 26 and the second detection electrodes 30.

The first lead-out wiring 28 is arranged on the substrate 12 of the external side area E0, an end thereof is electrically connected to the corresponding first detection electrodes 26, and the other end thereof is electrically connected to the flexible printed wiring board 34.

The second lead-out wiring 32 is arranged on the substrate 12 of the external side area E0, an end thereof is electrically connected to the second detection electrodes 30, and the other end is electrically connected to the flexible printed wiring board 34.

In FIG. 3, five lines of the first lead-out wiring 28 are illustrated and five lines of the second lead-out wiring 32 are illustrated. However, the numbers thereof are not particularly limited, and generally plural lines are arranged according to the numbers of the detection electrodes.

Examples of the materials for constituting the first lead-out wiring 28 and the second lead-out wiring 32 include metal such as gold (Au), silver (Ag), or copper (Cu), metal oxide such as tin oxide, zinc oxide, cadmium oxide, gallium oxide, and titanium oxide. Among these, for the reason of excellent conductivity, silver is preferable. The first lead-out wiring 28 and the second lead-out wiring 32 may be constituted with a metal paste such as a silver paste or a copper paste, or a thin film of metal or alloy such as aluminum (Al) or molybdenum (Mo). In the case of a metal paste, screen printing or an ink jet printing method is suitably used. In the case of metal or alloy thin films, a method for patterning a sputtering film by a photolithographic method or the like is suitably used.

In the first lead-out wiring 28 and the second lead-out wiring 32, in view of excellent adhesion to the substrate 12, a binder is preferably included. The types of the binder are as described above.

The flexible printed wiring board 34 is a plate in which plural lines of wiring and plural terminals are provided on the substrate, is connected respectively to the other ends of the first lead-out wiring 28 and respectively to the other ends of the second lead-out wiring 32, and has a role of electrically connecting the electrostatic capacitance-type touch panel sensor 18 and a device of an external portion (for example, the display device 24: see FIG. 2).

(First and second pressure sensitive adhesive layers)

The first pressure sensitive adhesive layer 16a is formed so as to cover the first conductive layer 14a constituting the first detection electrodes 26 having the conductive thin wire 36 in the mesh wiring pattern on the main surface of the substrate 12 on one side. The second pressure sensitive adhesive layer 16b is formed so as to cover the second conductive layer 14b constituting the second detection electrodes 30 having the conductive thin wire 36 in a mesh wiring pattern on the main surface of the substrate 12 on the other side.

The first pressure sensitive adhesive layer 16a and the second pressure sensitive adhesive layer 16b are layers causing the conductive thin wire 36 of the respective first and second conductive layers 14a and 14b to be adhered to the both main surfaces of the substrate 12 and are preferably optically transparent.

It is preferable that both of the first pressure sensitive adhesive layer 16a and the second pressure sensitive adhesive layer 16b are optically transparent. That is, the first pressure sensitive adhesive layer 16a and the second pressure sensitive adhesive layer 16b are preferably transparent pressure sensitive adhesive layers. The expression “optically transparent” means that the total light transmittance is 85% or greater, preferably 90% or greater, and more preferably 95% or greater.

The first pressure sensitive adhesive layer 16a and the second pressure sensitive adhesive layer 16b are constituted with pressure sensitive adhesives, pressure sensitive adhesive force of each of the pressure sensitive adhesive layers is preferably 15 N/25 mm or greater, more preferably 30 to 50 N/25 mm, and particularly preferably 30 to 42 N/25 mm.

With respect to the first pressure sensitive adhesive layer 16a and the second pressure sensitive adhesive layer 16b, the total moisture content of these two layers is preferably small, as long as the total moisture content of the three layers of the substrate 12, the first pressure sensitive adhesive layer 16a, and the second pressure sensitive adhesive layer 16b described above satisfies 1.0 g/m² or less. For example, the total moisture content is preferably 0.53 g/m² or less and more preferably 0.32 g/m² or less.

The reason is that, if the total moisture content of the two layers is, for example, 0.53 g/m² or less, the total moisture content of the three layers described above easily satisfies the range of 1.0 g/m² or less, and that the change of the electrostatic capacitance of the conductive film laminate 10 according to the invention can be reduced even in a high temperature and high humidity environment.

The moisture content of the first pressure sensitive adhesive layer 16a and the moisture content of the second pressure sensitive adhesive layer 16b are preferably adjusted according to the protective substrate (surface protection material) 22 that becomes a touch surface.

For example, in a case where the protective substrate 22 is glass, the moisture content on a side farther from the touch surface (the protective substrate 22) is preferably reduced, and in a case where the protective substrate 22 is a resin (plastic), the moisture content on a side closer to the touch surface is preferably reduced.

The pressure sensitive adhesive that can be used in the first and second pressure sensitive adhesive layers 16a and 16b is not particularly limited, and examples thereof include a (meth)acrylic pressure sensitive adhesive, a rubber-based pressure sensitive adhesive, a silicone-based pressure sensitive adhesive, an urethane-based pressure sensitive adhesive, and a polyester-based pressure sensitive adhesive. Among these, in view of heat resistance and weather resistance, a (meth)acrylic pressure sensitive adhesive is preferable. Here, the (meth)acrylic pressure sensitive adhesive refers to an acrylic pressure sensitive adhesive and/or a methacrylic pressure sensitive adhesive (methacrylic pressure sensitive adhesive). As this (meth)acrylic pressure sensitive adhesive, a (meth)acrylic pressure sensitive adhesive using a pressure sensitive adhesive sheet described below can be used.

The method for forming the pressure sensitive adhesive layer is not particularly limited, and for example, methods disclosed in JP2013-198990A can be used. Specific examples thereof include a coating method, a printing method, and a bonding method. Among these, a method for providing by coating and a method for forming the pressure sensitive adhesive layer by bonding a pressure sensitive adhesive sheet can be preferably used, and a method for forming the pressure sensitive adhesive layer by bonding a pressure sensitive adhesive sheet is more preferable.

The pressure sensitive adhesive sheets are pressure sensitive adhesive layers for adhering the substrate 12 respectively to the first detection electrodes 26 and the second detection electrodes 30, and are preferably optically transparent pressure sensitive adhesive sheets (transparent pressure sensitive adhesive sheets (OCA: Optical Clear Adhesive)). As the material for constituting the pressure sensitive adhesive sheet, well-known materials may be used. Here, as the pressure sensitive adhesive sheet for forming the pressure sensitive adhesive layer, a pressure sensitive adhesive sheet for a touch panel described below can be used.

As the environment for bonding the pressure sensitive adhesive sheet, bonding is preferably performed in an environment in which a dew point temperature is low. If bonding is performed in a low dew point environment, infiltration of moisture into the pressure sensitive adhesive layer can be reduced and prevented, and thus there is an effect that resistance increase of the conductive layer is suppressed. The dew point temperature is preferably −40° C. or less, and particularly the dew point temperature is preferably −60° C. or less. After the pressure sensitive adhesive sheet is bonded, an autoclave treatment is preferably performed. According to an autoclave treatment, there in an effect that optical properties such as enhancement of adhesion force of the pressure sensitive adhesive layer to the conductive layer and the substrate, transmittance enhancement of the conductive film laminate, and haze reduction are improved.

The thicknesses of respective layers of the first pressure sensitive adhesive layer 16a and the second pressure sensitive adhesive layer 16b are not particularly limited, and can be appropriately selected according to the purpose. For example, the thickness is preferably 25 to 300 μm and more preferably 50 to 100 μm. If the thickness of each of the layers is caused to be 25 μm or greater, effects that the level difference and unevenness of the bonded first and second conductive layers 14a and 14b and the substrate 12 can be covered, and the first and second conductive layers 14a and 14b and the substrate 12 can be adhered to each other can be obtained. If the thickness of each of the layers is caused to be 300 μm or less, effects that the transmittance of the first and second pressure sensitive adhesive layers 16a and 16b can be sufficiently secured, thickness can be reduced, the moisture contents of the first and second pressure sensitive adhesive layers 16a and 16b, and also the total moisture content of the two layers can be suppressed can be obtained.

In the conductive film laminate 10 according to the invention, the total moisture content of the three layers of the substrate 12, the first pressure sensitive adhesive layer 16a, and the second pressure sensitive adhesive layer 16b is 1.0 g/m² or less. According to the invention, if the total moisture content of these three layers satisfies the range described above, the total moisture content is preferably small, and for example, the total moisture content is preferably 0.7 g/m² or less.

The reason is that, if the total moisture content of the three layers is 1.0 2.⁻/m² or less, the change of the electrostatic capacitance of the conductive film laminate 10 according to the invention, specifically, the change of the electrostatic capacitance between the first conductive layer 14a and the second conductive layer 14b of the electrostatic capacitance-type touch panel sensor 18, can be reduced even in a high temperature and high humidity environment.

The conductive film laminate and the touch panel sensor according to the invention are basically constituted as above.

(Touch Panel)

Subsequently, as described above, the touch panel 20 illustrated in FIG. 2 respectively has the protective substrate 22 and the display device 24 on both external sides of the conductive film laminate 10 according to the invention.

(Protective Substrate)

The protective substrate 22 is arranged on the first pressure sensitive adhesive layer 16a (an upper surface in the drawing) and is a substrate that is fixed to the electrostatic capacitance-type touch panel sensor 18 by the first pressure sensitive adhesive layer 16a, and achieves a role as a protective cover that protects the electrostatic capacitance-type touch panel sensor 18, particularly, the first and second conductive layers 14a and 14b from the environment of the external portion, and the main surface thereof constitutes a touch surface in which an operator performs an operation with a finger, a pen, or the like.

The protective substrate 22 is preferably a transparent substrate, and a plastic film, a plastic plate, a glass plate and the like can be used. The thickness of the protective substrate 22 is not particularly limited, and it is desirable that the thickness is appropriately selected according to respective uses.

As raw materials of the plastic film and the plastic plate, for example, polyesters such as polyethylene terephthalate (PET) and polyethylene naphthalate (PEN); polyolefins such as polyethylene (PE), polypropylene (PP), polystyrene, an ethylene-vinyl acetate copolymer (EVA); a vinyl-based resin; and additionally polycarbonate (PC), polyamide, polyimide, an acryl resin, triacetyl cellulose (TAC), a cycloolefin-based resin (COP), and the like can be used.

As the protective substrate 22, a polarization plate, a circularly polarizing plate, and the like may be used.

(Display Device)

The display device 24 is a device (display) having a display surface for displaying an image, an external side surface (a lower surface in the drawing) of the second pressure sensitive adhesive layer 16b of the conductive film laminate 10 is arranged on this display screen side (an upper surface in the drawing), the electrostatic capacitance-type touch panel sensor 18, specifically, the conductive film laminate 10 with the protective substrate 22 is fixed by the second pressure sensitive adhesive layer 16b.

The types of the display device 24 are not particularly limited, and the well-known display device can be used. Examples thereof include a cathode ray tube (CRT) display device, a liquid crystal display device (LCD), an organic light emitting diode (OLED) display device, a vacuum fluorescent display (VFD), a plasma display panel (PDP), a surface-conduction electron-emitter display (SED), or a field emission display (FED), or an electronic paper (E-Paper).

The user checks an image for an input operation displayed on the display screen of the display device 24 of the touch panel 20 constituted in this manner and can perform various input operations through the touch panel sensor 18 by causing the touch surface of the protective substrate 22 corresponding to the image for the input operation or the like to be touched.

An interface of an electrical device transitions from an era of the graphic user interface to an era of a more intuitive touch sensing, and a mobile use environment other than a mobile telephone is developed. Also in an electrostatic capacitance-type touch panel mounded mobile device, the use thereof starts from a small smart phone and expands to a medium-sized tablet or note-type PC and tendency of enlarging a screen size used becomes stronger.

The number of lines of the operation (the number of detection electrodes) increases according, to the increase of the size of an input area in which a contact of an electrostatic capacitance-type touch panel sensor to an object can be detected in the diagonal direction. Therefore, it is necessary to compress the required time for scanning for each line. In order to maintain an appropriate sensing environment in a mobile use, an object is to reduce the parasitic capacitance of the electrostatic capacitance-type touch panel sensor and the change amount of the electrostatic capacitance. In the conductive film laminate in the related art, a change of the electrostatic capacitance in a high temperature and high humidity environment is great, and as the size increases, there is a concern that sensing, programs cannot be followed (malfunction occurs). Meanwhile, in a case where the conductive film laminate according to the invention, in which the total moisture content of the substrate and the pressure sensitive adhesive layer is small and the change amount of the electrostatic capacitance is small is used, as the size of the input area (sensing portion) in which the contact of the electrostatic capacitance-type touch panel sensor to the object can be detected in the diagonal direction is greater than 5 inches, the more appropriate sensing environment can be obtained. If the size thereof is preferably 8 inches or greater and more preferably 10 inches or greater, a great effect for suppressing malfunction can be exhibited. The shape of the input area indicated by the size is a rectangular shape.

Here, it is considered that the reason of the occurrence of the electrostatic capacitance change in a case where the moisture content of the three layers of the first pressure sensitive adhesive layer, the substrate, and the second pressure sensitive adhesive layer is high is that, if moisture exists in these three layers, permittivity of water is as extremely high as 80.4 (20° C.), and thus average permittivity between the electrodes (first and second conductive layers) becomes higher, such that electrostatic capacitance increases. The reason can be explained from the fact that the inventors have found that the average permittivity of the pressure sensitive adhesive and the moisture influence to the electrostatic capacitance, since leaking stray current of the electric field to the first and second pressure sensitive adhesive layers on the external sides of the electrodes (first and second conductive layers) exists.

(Method for Manufacturing Conductive Film Laminate)

A method for manufacturing the conductive film laminate 10 according to the invention is not particularly limited, but the well-known method can be employed.

In the conductive film laminate 10 according to the invention, not only at the detection area E1 having the first and second detection electrodes 26 and 30 but also at the external side area E0 having the first and second lead-out wiring 28 and 32 as a whole, the first and second conductive layers 14a and 14b can be formed respectively on both main surfaces of the substrate 12, so as to manufacture the touch panel sensor 18.

Subsequently, the conductive film laminate 10 according to the invention can be manufactured by respectively forming the first and second pressure sensitive adhesive layers 16a and 16b on the first and second conductive layers 14a and 14b.

(Method for Forming Conductive Film)

First, examples of the method for forming the first and second conductive layers 14a and 14b include a method of performing exposure and development treatments on a resist film on a metal foil formed on the both main surfaces of the substrate 12, forming a resist pattern, and etching the metal foil exposed from the resist pattern, so as to form a conductive layer. Examples of the method for forming the conductive layer include a method of printing a paste including metal fine particles or metal nanowires on the both main surfaces of the substrate 12, firing the paste, and performing metal plating. Examples of the method for forming the conductive layer include a method for forming the conductive layer by performing printing on the substrate 12 by a screen printing plate or a gravure printing plate or a method for forming the conductive layer by ink jet.

In addition to the methods above, examples of the method for forming the conductive layer include a method using silver halide. Specific examples thereof include (1) a step of forming silver halide emulsion layers (hereinafter, simply referred to as photosensitive layers) containing silver halide and binders respectively on both surfaces of the substrate 12 and (2) a step of performing a development treatment after the photosensitive layer is exposed.

Hereinafter, respective steps are described.

[Step (1): Photosensitive Layer Forming Step]

Step (1) is a step of forming photosensitive layers containing silver halide and binders on both surfaces of the substrate 12.

The method for forming the photosensitive layer is not particularly limited. However, in view of productivity, a method for forming the photosensitive layers on the both surfaces of the substrate 12 by bringing a composition for foming the photosensitive layers containing silver halide and the binders into contact with the substrate 12 is preferable.

Hereinafter, after the embodiment of the composition for forming the photosensitive layer used in the method is described, the order of the steps is described.

Silver halide and the binders are contained in the composition for forming the photosensitive layer.

The halogen element contained in silver halide may be any one of chlorine, bromine, iodine, and bromine, or may be a combination thereof. As the silver halide, for example, silver halide having silver chloride, silver chloride, and silver iodide, as a main body is preferably used, and further silver halide having silver bromide and silver chloride as a main body is preferably used.

The types of the binder used are as described above. The binder may be included in the composition for forming the photosensitive layer in the form of latex.

The volume ratio of silver halide and the binder included in the composition for forming the photosensitive layer is not particularly limited and is appropriately adjusted such that the volume ratio of metal and the binder in the conductive thin wire 36 is in a suitable range.

A solvent is contained in the composition for forming the photosensitive layer, if necessary.

Examples of the solvent used include water, an organic solvent (for example, alcohols such as methanol, ketones such as acetone, amides such as formamide, sulfoxides such as dimethyl sulfoxide, esters such as ethyl acetate, and ethers), an ionic liquid, or a mixed solvent thereof.

The content of the solvent used is not particularly limited but is preferably in the range of 30% by mass to 90% by mass and more preferably in the range of 50% by mass to 80% by mass with respect to the total mass of the silver halide and the binders.

(Order of Steps)

The method for bringing the composition for forming the photosensitive layer and the substrate 12 into contact with each other is not particularly limited, and well-known methods can be employed. Examples thereof include a method of coating the substrate 12 with the composition for forming the photosensitive layer or immersing the substrate 12 in the composition for forming the photosensitive layer.

The content of the binder in the formed photosensitive layer is not particularly limited, but the content is preferably 0.3 g/m² to 5.0 g/m² and more preferably 0.5 g/m² to 2.0 g/m2.

The content of the silver halide in the photosensitive layer is not particularly limited, but since the conductive properties of the conductive thin wire 36 are more excellent, the content in terms of silver is preferably 1.0 g/m² to 20.0 g/m² and more preferably 5.0 g/m² to 15.0 g/m².

If necessary, the protective layer consisting of the binder may be further provided on the photosensitive layer. If the protective layer is provided, improvements on scratch prevention or dynamic characteristics are obtained.

[Step (2): Exposure development step]

Step (2) is a step of performing the development treatment after pattern exposure is performed on the photosensitive layer obtained in Step (1) above so as to form the first conductive layer 14a (the first detection electrodes 26 and the first lead-out wiring 28) consisting of the mesh-shaped conductive thin wire 36 and the second conductive layer 14b (the second detection electrodes 30 and the second lead-out wiring 32) consisting of the mesh-shaped conductive thin wire 36.

First, a pattern exposure treatment is described, and thereafter, a development treatment is described.

(Pattern Exposure)

Silver halide in the photosensitive layer at the exposure area forms a latent image by performing pattern-shaped exposure on the photosensitive layer. The area in which this latent image is formed forms mesh-shaped metal thin wire by a development treatment described below. Meanwhile, at a non-exposure area which is not exposed, at the time of the fixing treatment described below, silver halide is dissolved and flows out from the photosensitive layer, a transparent film can be obtained, and thus an opening area that becomes a light transmission part is formed.

The light source used at the time of exposure is not particularly limited, and examples thereof include light such as visible light rays, ultraviolet rays or radiation such as X rays.

The method for performing the pattern exposure is not particularly limited, and may be performed, for example, by surface exposure in which a photo mask is used or by scanning exposure by laser beams. The shape of the pattern is not particularly limited and appropriately adjusted according to the patter of metal thin wire desired to be formed.

(Development Treatment)

The method of the development treatment is not particularly limited, and well-known methods can be employed. For example, a common technology of the development treatment used for a silver halide photographic film, photographic paper, a printing plate making film, an emulsion mask for photo mask can be used.

The types of the developer used at the time of the development treatment are not particularly limited, but, for example, a PQ developer, an MQ developer, an MAA developer, or the like can be used. Examples of commercially available products include developers, processes such as CN-16, CR-56, CP45X, FD-3, and PAPITOL, which are used in Fujifilm Corporation, and processes such as such as C-41, E-6, RA-4, D-19, D-72, which are used in KODAK, and developers included in kits thereof can be used. A lithographic developer can be used.

The development treatment can include a fixing treatment performed for the purpose of stabilization by removing silver salts in the non-exposure portion. In the fixing treatment, a technique of the fixing treatment used in a silver halide photographic film, photographic printing paper, a film for a printing plate, an emulsion mask for a photo mask can be used.

The mass of the metal silver included in the exposure portion (metal thin wire) after the development treatment is preferably the content of 50% by mass or greater and even more preferably 80% by mass or greater with respect to the mass of the silver included in the exposure portion before the exposure. If the mass of silver included in the exposure portion is 50% by mass or greater with respect to the mass of silver included in the exposure portion before exposure, it is preferable since high conductivity can be obtained.

In addition to the steps described above, a step for forming undercoat, a step for forming an antihalation layer, or a heating treatment may be performed, if necessary.

(Undercoat Forming Step)

For the reason that adhesion between the substrate 12 and the silver halide emulsion layer is excellent, before Step (1) describe above, it is preferable to perform a step of forming undercoat including the binders on the both surfaces of the substrate 12.

The binders used are as described above. The thickness of the undercoat is not particularly limited, but, since the change ratio of the adhesion and the mutual electrostatic capacitance is further suppressed, the thickness thereof is preferably 0.01 μm to 0.5 μm and more preferably 0.01 μm to 0.1 μm.

(Antihalation Layer Forming Step)

Since thin wire of the conductive thin wire 36 can he formed, it is preferable to perform a step of forming the antihalation layer on the undercoat.

(Step (3): Heating Step)

Step (3) is a step of performing a heating treatment after the development treatment. If this step is performed, fusion occurs between the binders, such that the hardness of the conductive thin wire 36 further increases. Particularly, in a case where polymer particles are dispersed in the composition for forming the photosensitive layer as the binders (in a case where the binders are polymer particles in the latex), fusion between polymer particles occurs by performing this step, so as to form the conductive thin wire 36 exhibiting desired hardness.

With respect to the condition of a heating treatment, a appropriately suitable condition according to the binders used is selected, but the condition is preferably 40° C. or greater, more preferably 50° C. or greater, and even more preferably 60° C. or greater, in view of the film forming temperature of the polymer particles. In view of suppressing curling of the substrate or the like, the condition is preferably 150° C. or less and more preferably 100° C. or less.

The heating time is not particularly limited, but in view of suppressing curling of the substrate or the like and in view of productivity, the heating time is preferably 1 minute to 5 minutes and more preferably 1 minute to 3 minutes.

Since the heating treatment is generally performed together with a drying step performed after the exposure and development treatment, there is no need to increasing a new step for forming polymer particles, and the heating treatment is excellent, in view of productivity, cost, and the like.

Light-transmitting portions including the binders are formed in the opening area between the conductive thin wire 36 and the opening area between the conductive thin wire 36 by performing the steps described above. With respect to the transmittance in the light-transmitting portion, the transmittance in the area in the wavelength of 380 nm to 780 nm, that is, transmittance exhibiting the minimum value of the visible light transmittance is preferably 90% or greater, more preferably 95% or greater, even more preferably 97% or greater, particularly preferably 98% or greater, and most preferably 99% or greater.

A material other than the binder may be included in the light-transmitting portion. Examples thereof include a silver hardly dissolving solvent. Here, examples of the silver hardly dissolving solvent include alcohols such as methanol, ketones such as acetone, amides such as formamide, sulfoxides such as dimethyl sulfoxide, esters such as ethyl acetate, and ethers.

(Method for Forming Pressure Sensitive Adhesive Layer)

Subsequently, examples of the method for forming the first and second pressure sensitive adhesive layers 16a and 16b include a method of respectively coating the first and second conductive layers 14a and 14b with the pressure sensitive adhesive, a printing method, and a method of bonding pressure sensitive adhesive sheets made of pressure sensitive adhesives.

Here, as the method for forming, the pressure sensitive adhesive layer, a method for bonding the pressure sensitive adhesive sheets made of the pressure sensitive adhesives onto the conductive layer is preferable. As this pressure sensitive adhesive sheet, a pressure sensitive adhesive sheet for a touch panel disclosed in JP2013-171225 according to the application of the present applicant can be used. Such a pressure sensitive adhesive sheet is manufactured as below. Hereinafter, a method for manufacturing this pressure sensitive adhesive sheet is described.

(Method for Manufacturing Pressure Sensitive Adhesive Sheet)

The method for manufacturing the pressure sensitive adhesive sheet described above is not particularly limited and can be manufactured by the well-known methods. Examples thereof include a method for coating a predetermined substrate (for example, a peeling, sheet) with a (meth)acrylic pressure sensitive adhesive composition (hereinafter, simply referred to as a “composition”) including a (meth)acrylic pressure sensitive adhesive and hydrophobic additive and performing a hardening treatment if necessary, so as to form a pressure sensitive adhesive sheet. After the pressure sensitive adhesive sheet is formed, a peeling sheet may be laminated on the exposed surface of the formed pressure sensitive adhesive sheet, if necessary.

As the (meth)acrylic pressure sensitive adhesive composition, a composition including a (meth)acrylic polymer before crosslinking, a crosslinking agent, and a hydrophobic additive may be used.

Hereinafter, respective constitutional elements of the composition and a method using the composition are described.

The (meth)acrylic pressure sensitive adhesive is a pressure sensitive adhesive including a (meth)acrylic polymer as a base polymer.

The (meth)acrylic adhesive may be formed by causing a crosslinking agent to react with a (meth)acrylic polymer that reacts with a crosslinking agent, so as to have a crosslinking structure.

The (meth)acrylic polymer that reacts with the crosslinking agent preferably has a repeating unit derived from a (meth)acrylate monomer having a hydroxyl group, a carboxyl group, or the like.

Examples of the (meth)acrylate monomer having a hydroxyl group include 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, and 12-hydroxylauryl (meth)acrylate.

In a case where the repeating unit derived from the (meth)acrylate monomer having the hydroxyl group (hereinafter, simply referred to as a repeating unit Y) is included in a (meth)acrylic polymer, since effects are more excellent, the content of the repeating unit Y is preferably 0.1 to 10 mol % and more preferably 0.5 to 5 mol % with respect to the total repeating unit of the (meth)acrylic polymer.

The method for polymerizing the (meth)acrylic pressure sensitive adhesive used in the invention is not particularly limited, but can be polymerized by well-known methods such as solution polymerization, emulsion polymerization, bulk polymerization, suspension polymerization, and alternating copolymerization. The obtainable copolymer may be any one of a random copolymer and a block copolymer.

The content of the (meth)acrylic pressure sensitive adhesive in the pressure sensitive adhesive sheet is not particularly limited. However, since the effect of the invention is excellent, the content thereof is preferably 25 to 400 parts by mass and more preferably 66 to 150 parts by mass with respect to 100 parts by mass of the hydrophobic additive described below.

(Hydrophobic Additive)

The hydrophobic additive is a compound for causing the pressure sensitive adhesive sheet to be hydrophobic.

The ratio of the number of moles of oxygen atoms and the number of moles of carbon atoms in the hydrophobic additive (O/C ratio: the number of moles of oxygen atoms/the number of moles of carbon atoms) is 0 to 0.10. Since any one of transparency and the adhesion of the pressure sensitive adhesive sheet, malfunction of the touch panel or suppression of is excellent, the ratio thereof is preferably 0 to 0.05 and more preferably 0 to 0.01.

The hydrophobic additive is not particularly limited, as long as the O/C ratio is satisfied, but examples thereof include a fluorine atom-containing resin and a silicon atom-containing resin, in addition to the well-known viscosity imparting agent.

In view of exhibiting excellent effects according to the invention, suitable embodiments of the hydrophobic additive include viscosity imparting agents such as a petroleum resin (for example, an aromatic petroleum resin, an aliphatic petroleum resin, and a resin from C9 fractions), a terpene resin (for example, an α-pinene resin, a β-pinene resin, a terpene phenol copolymer, a hydrogenated terpene phenol resin, an aromatic modified terpene resin, and an abietic acid ester-based resin), a rosin-based resin (for example, a partially hydrogenated gum rosin resin, an erythritol modified wood rosin resin, a tall oil rosin resin, and a wood rosin resin), a coumarone indene resin (for example, a chroman indene-styrene copolymer), a styrene resin (for example, polystyrene, and a copolymer of styrene and a-methyl styrene).

Among the viscosity imparting agents, in view of exhibiting excellent effects according to the invention, a hydrogenated terpene phenol resin and an aromatic modified terpene resin are preferable.

The viscosity imparting agents may be used singly or two or more types thereof may be used in combination. In a case where the two or more types thereof are used, for example, different types of resins may be combined, or resins which are in the same type but have different softening points may be combined.

The content of the hydrophobic additive in the pressure sensitive adhesive sheet is 20 to 80% by mass with respect to the total mass of the pressure sensitive adhesive sheet. Among these, in view of exhibiting excellent effects according to the invention, the content thereof is preferably 40 to 60% by mass.

In a case where the content is less than 20% by mass, it is hard to reduce the temperature dependency of the relative permittivity of the pressure sensitive adhesive sheet, and as a result, it is easy to generate malfunction of the touch panel. In a case where the content is greater than 80% by mass, adhesion is deteriorated.

(Arbitrary Components)

In the pressure sensitive adhesive sheet, components in addition to the (meth)acrylic pressure sensitive adhesive and the hydrophobic additive may be included.

Examples thereof include a plasticizer. As the plasticizer, a phosphoric acid ester-based plasticizer and/or a carboxylic acid ester-based plasticizer are preferable. As the phosphoric acid ester-based plasticizer, for example, triphenyl phosphate, tricresyl phosphate, cresyl diphenyl phosphate, octyl diphenyl phosphate, biphenyl diphenyl phosphate, trioctyl phosphate, and tributyl phosphate are preferable. As the carboxylic acid ester-based plasticizer, for example, dimethyl phthalate, diethyl phthalate, dihutyl phthalate, dioctyl phthalate, diphenyl phthalate, diethyl hexyl phthalate, O-acetyl triethyl citrate, O-acetyl tributyl citrate, acetyl triethyl citrate, acetyl tributyl citrate, butyl oleate, methyl ricinoleate acetyl, dibutyl sebacate, triacetin, tributyrin, butyl phthalyl butyl glycolate, ethyl phthalyl ethyl glycolate, methyl phthalyl ethyl glycolate, and butyl phthalyl butyl glycolate are preferable.

The addition amount of the plasticizer is preferably 0.1 to 20% by mass and more preferably 5.0 to 10.0% by mass with respect to the total mass of the pressure sensitive adhesive sheet.

As described above, the composition may include (meth)acrylic pressure sensitive adhesive described above (or a (meth)acrylic polymer having a reactive group that reacts with a crosslinking agent described below) and other components in addition to the hydrophobic additive.

For example, the composition may include a crosslinking agent, if necessary. Examples of the crosslinking agent include an isocyanate compound, an epoxy compound, a melamine resin, an aziridine derivative, and a metal chelate compound. Among these, in view of mainly obtaining appropriate cohesive force, an isocyanate compound or an epoxy compound are particularly preferable. These compounds may be used singly or two or more types thereof may be used in combination.

The usage amount of the crosslinking agent is not particularly limited, but the usage amount thereof is preferably 0.01 to 10 parts by mass and more preferably 0.1 to 1 part by mass with respect to 100 parts by mass of the (meth)acrylic polymer having a reactive group that reacts with the crosslinking agent.

If necessary, the composition may include a solvent. Examples of the used solvent include water, an organic solvent (for example, alcohols such as methanol, ketones such as acetone, amides such as formamide, sulfoxides such as dimethyl sulfoxide, esters such as ethyl acetate, and ethers), or a mixed solvent thereof.

In addition to the above, various additives in the related art such as a surface lubricant, a leveling agent, an antioxidant, a corrosion inhibitor, a light stabilizer, an ultraviolet absorbing agent, a polymerization inhibitor, a silane coupling agent, an inorganic or organic filler, metal powders, powders such as pigments, particulates, and a foil-like material are appropriately added to the composition, according to the use thereof.

The method for forming the pressure sensitive adhesive sheet from the composition is not particularly limited, and the well-known methods can be employed. Examples thereof include a predetermined substrate (for example, a peeling sheet) is coated with the composition, and a hardening treatment is performed, if necessary, so as to form a pressure sensitive adhesive sheet. After the pressure sensitive adhesive sheet is formed, a peeling sheet may be laminated on the pressure sensitive adhesive sheet surface.

Examples of the composition coating method include a gravure coater, a comma coater, a bar coater, a knife coater, a die coater, and a roll coater.

Examples of the hardening treatment include a heat hardening treatment or a light hardening treatment.

The pressure sensitive adhesive sheet may be a type (a pressure sensitive adhesive sheet without a substrate) having a substrate and a type (a pressure sensitive adhesive sheet with a substrate, for example, a double-sided pressure sensitive adhesive sheet with a substrate having pressure sensitive adhesive layers on both surfaces of the substrate and a one-sided pressure sensitive adhesive sheet with a substrate having a pressure sensitive adhesive layer only on one side of the substrate) having a substrate in which a pressure sensitive adhesive layer is arranged on the main surface of the substrate at least on one side.

In a case where there are peeling sheets, two pressure sensitive adhesive sheets manufactured as described above are respectively arranged, bonded, and adhered on the first and second conductive layers 14a and 14b formed on the both main surfaces of the substrate 12 after the peeling sheets on the bonding, side are peeled off, the first and second pressure sensitive adhesive layers 16a and 16b are respectively formed, so as to manufacture the conductive film laminate 10 according to the invention.

(Method for Manufacturing Touch Panel)

The touch panel according to the invention can be manufactured by arranging, bonding, and adhering the second pressure sensitive adhesive layer 16b of the conductive film laminate 10 on the display screen of the display device 24, together with arranging, bonding, and adhering the protective substrate 22 on the first pressure sensitive adhesive layer 16a of the conductive film laminate 10 according to the invention which is manufactured in this manner.

Any one of the adhering of the protective substrate 22 to the first pressure sensitive adhesive layer 16a and the adhering of the second pressure sensitive adhesive layer 16b to the display screen of the display device 24 may be performed first.

The conductive film laminate and the touch panel according to the invention are basically constituted as above.

In the above, the conductive film laminate and the touch panel according to the invention are described in detail, but the invention is not limited thereto, but various types of modifications or changes can be performed without departing from the gist of the invention.

### EXAMPLES

### Examples

Hereinafter, the invention is described in detail with reference to examples.

First, in an order as below, the conductive film laminate 10 according to the invention as illustrated in FIG. 1 is manufactured so as to be an example.

Materials, usage amounts, ratios, treatment details, treatment order, and the like can be appropriately changed without departing from the gist of the invention. That is, the scope of the invention is not interpreted in a limited manner.

(Preparation of Silver Halide Emulsion)

Liquid 2 below and Liquid 3 below in amounts respectively corresponding to 90% were added to Liquid 1 below which was maintained at 38° C. and pH 4.5 over 20 minutes under stirring, so as to form nuclear particles of 0.16 μm. Subsequently, Liquid 4 below and Liquid 5 below are added thereto over 8 mintues, Liquid 2 below and Liquid 3 below in amounts respectively corresponding to 10% were added thereto over 2 minutes, so as to grow the nuclear particles to 0.21 μm. 0.15 g of potassium iodide was added thereto and matured for five minutes, so as to complete the forming of the particles.

Liquid 1:

| | | |
|---|---|---|
| Water | 750 | ml |
| Gelatin | 9 | g |
| Sodium chloride | 3 | g |
| 1,3-dimethylimidazolidine-2-thione | 20 | mg |
| Sodium benzenethiosulfonate | 10 | mg |
| Citric acid | 0.7 | g |

Liquid 2:

| | | |
|---|---|---|
| Water | 300 | ml |
| Silver nitrate | 150 | g |

Liquid 3:

| | | |
|---|---|---|
| Water | 300 | ml |
| Sodium chloride | 38 | g |
| Potassium bromide | 32 | g |
| Potassium hexachloroiridate (III) | 8 | ml |
| (0.005% KCl 20% aqueous solution) | | |
| Ammonium hexachlororhodate | 10 | ml |
| (0.001% NaCl 20% aqueous solution) | | |

Liquid 4:

| | | |
|---|---|---|
| Water | 100 | ml |
| Silver nitrate | 50 | g |

Liquid 5:

| | | |
|---|---|---|
| Water | 100 | ml |
| Sodium chloride | 13 | g |
| Potassium bromide | 11 | g |
| Yellow prussiate of potash | 5 | mg |

Thereafter, water washing was performed by a flocculation method. Specifically, the temperature was decreased to 35° C., and pH was decreased by using a sulfuric acid until silver halide precipitated (ph was in the range of pH 3.6±0.2). Subsequently, 3 liters of a supernatant solution was removed (first water washing). Sulfuric acid was added until silver halide precipitates while three liters of distilled water was added. Again, three liters of distilled water was removed (second water washing). The same operation as the second water washing, was further performed once (third water washing), and a water washing-deionization step was completed. The emulsion after water washing-deionization was adjusted to pH 6.4 and pAg 7.5, 3.9 g of gelatin, 10 mg of sodium benzenethiosulfonate, 3 mg of sodium benzenethiosulfonate, 15 mg of sodium thiosulfate, and 10 mg of chloroauric acid were added thereto, chemical sensitization was performed so as to obtain optimum sensitivity at 55° C., and 100 mg of 1,3,3a,7-tetraazaindene as a stabilizer, 100 mg of PROXEL (Product name, manufactured by ICI Co., Ltd.) as a preservative were added. The finally obtained emulsion was silver chloroiodobromide cubic particle emulsion in which 0.08 mol % of silver iodide was included, the ratio of silver chlorobromide was 70 mol % of silver chloride and 30 mol % of silver bromide, an average particle diameter was 0.22 μm, and a coefficient of variation was 9%.

(Preparation of the Composition for Forming the Photosensitive Layer)

1.2×10⁻⁴ mol/mol Ag of 1,3,3a,7-tetraazaindene, 1.2 x 10⁻² mol/mol Ag of hydroquinone, 3.0×10⁴ mol/mol Ag of citric acid, and 0.90 g/mol Ag of 2,4-dichloro-6-hydroxy-1,3,5-triazine sodium salt were added to the emulsion, and pH of the coating liquid was adjusted to 5.6 by using citric acid, so as to obtain the composition for forming the photosensitive layer.

(Photosensitive Layer Forming Step)

Gelatin layers having the thickness of 0.1 μm, as an undercoat were provided on both surfaces of a cycloolefin polymer (COP) resin sheet (ZEONOR (Registered trademark) manufactured by ZEON Corporation) having the width of 30 cm and the thickness of 40 μm which became the substrate 12 of the conductive film laminate 10 illustrated in FIG. 1, and antihalation layers having optical density of about 1.0 and including a dye that was decolorized by alkali of a developer were further provided on the undercoat.

The antihalation layers were coated with the composition for forming the photosensitive layer in the width of 25 cm by 20 cm, gelatin layers having the thickness of 0.15 μm were further provided, coating at both ends was removed by 3 cm each such that coating in a central portion was remained by 24 cm, so as to obtain a PET sheet in which the photosensitive layers were formed on the both surfaces. The photosensitive layers formed on the COP sheet with these photosensitive layers had a silver amount of 4.8 em'⁻ and a gelatin amount of 1.0 g/m².

(Exposure Development Step)

Photo masks having electrode patterns of the first detection electrodes 26 and the second detection electrodes 30 were manufactured, and exposure was performed on the COP sheet with the photosensitive layers via photo masks by using parallel light having a high pressure mercury lamp as a light source. After the exposure, development was performed with a developer described below, and a development treatment was further performed by using a fixer (Product name: N3X-R for CN16X, manufactured by Fujifilm Corporation). Rinse was performed with pure water, and drying was performed, so as to obtain the touch panel sensor 18 comprising the first conductive layer 14a including the first detection electrodes 26 and the second conductive layer 14b including the second detection electrodes 30 which were consisting of Ag thin wire on both surfaces of the substrate 12.

(Electrode Pattern)

The electrode pattern of the first detection electrodes 26 and the second detection electrodes 30 was a square shape in which a length of one side of each of the lattices 38 was 175 μm, an intersecting angle of the Ag thin wire constituting a mesh was 90° , and a line width of Ag thin wire was 4.5 μm.

The obtained touch panel sensor 18 was constituted with Ag thin wire in which the first detection electrodes 26 and the second detection electrodes 30 were intersect with each other in a mesh shape. As described above, the first detection electrodes 26 were electrodes extending in the x direction and the second detection electrodes 30 extending in the y direction, and respectively arranged on the substrate (COP sheet) 12 at the pitch of 350 μm.

Subsequently, the conductive film laminate 10 was manufactured.

A transparent pressure sensitive adhesive sheet (acryl gel sheet: MAYCLEAN GEL (Registered trademark) MGSFX (manufactured by Kyodo Giken Chemical Co., Ltd.)) having the thickness of 100 μm was arranged by using the obtained touch panel sensor 18 on the both surfaces on the external sides (upper and lower sides in the drawing) (external side surfaces of the first conductive layer 14a and the second conductive layer 14b) of the touch panel sensor 18, and this was interposed between glass substrates having the thickness of 5 mm from the both surfaces and bonded by using a roller having a load of 2 kgf, so as to form the first pressure sensitive adhesive layer 16a and the second pressure sensitive adhesive layer 16b. Thereafter, the obtained conductive film laminate 10 were bleached in the environment of 40° C. and 5 atmospheric pressure, for 20 minutes in a high pressure constant-temperature tank.

In this manner, as illustrated in FIG. 1, the conductive film laminate 10 in which the first pressure sensitive adhesive layer 16a, the first conductive layer 14a (the first detection electrodes 26), the substrate 12, the second conductive layer 14b (the second detection electrodes 30), and the second pressure sensitive adhesive layer 16b were laminated in an order from the viewing side (the upper side in the drawing) to the opposite side (the middle in the drawing) was obtained.

The conductive film laminate 10 obtained in this manner was cut into a rectangular shape of 4 cm×5 cm, so as to obtain Example 1.

Conductive film laminates were manufactured in which types and thicknesses of the substrate 12 and types and thicknesses of pressure sensitive adhesive sheets to be the first and second pressure sensitive adhesive layers 16a and 16b were respectively changed and cut into a predetermined rectangular shape, so as to obtain Examples 2 and 3 and Comparative Examples 1 to 3.

In each of Examples 1 to 3 and Comparative Examples 1 to 3, the type, the thickness, and the moisture content of the substrate 12, the types, the thicknesses, and the moisture contents of the pressure sensitive adhesive sheets to be the first and second pressure sensitive adhesive layers 16a and 16b, and the total moisture content which was the total moisture content of the three layers of the substrate 12 and the first and second pressure sensitive adhesive layers 16a and 16b are shown in Table 1.

Here, as the substrate 12, a heat resistant transparent resin film (ARTON (Registered trademark) manufactured by JSR Corporation) and a polyethylene terephthalate (PET) sheet (manufactured by Toyobo Co., Ltd.) were used.

As the transparent pressure sensitive adhesive sheet (OCA), high transparency adhesive transfer tape (OCA TAPE 8164 (manufactured by Sumimoto 3M Limited) and trial piece: OS 130297 (manufactured by Fujifilm Corporation) were used.

With respect to the method for manufacturing OS 130297, 21.8 parts by mass of an esterified product (Product name: UC203, manufactured by Kuraray Co., Ltd., Molecular weight: 36,000) of a maleic anhydride adduct of a polyisoprene polymer and 2-hydroxyethyl methacrylate, 11.4 parts by mass of polybutadiene (Product name: Polyvest110, manufactured by Evonik Industries AG), 5 parts by mass of dicyclopentenyloxyethyl methacrylate (Product name: FA5I2M, manufactured by Hitachi Chemical Co, Ltd.), 20 parts by mass of 2-ethylhexyl methacrylate (manufactured by Wako Pure Chemical Industries, Ltd.), and 38.8 parts by mass of a terpene-based hydrogenated resin (Product name: CLEARON P-135, manufactured by Yasuhara Chemical Co., Ltd.) were kneaded by a keader in a constant-temperature tank at 130° C. Subsequently, the temperature of the constant-temperature tank was adjusted to 80° C., and 0.6 parts by mass of the photopolymerization initiator (Product name: Lucirin TPO, manufactured by BASF SE) and 2.4 parts by mass of a photopolymerization initiator (Product name: IRGACURE 184, manufactured by BASF SE) were introduced and kneaded by a keader, so as to prepare OS130297.

A surface treated surface of a predetermined peeling film (heavy peeling film) having the thickness of 75 μm was coated with OS1.30297 obtained such that the thickness of the formed pressure sensitive adhesive layer became the thickness of 50 μm, and the surface treated surface of a predetermined peeling film (light peeling film) having the thickness of 50 μm was bonded onto the obtained coated film. The coated film interposed between the peeling films was irradiated with UV light such that an irradiation energy became 3 J/cm² by using a parallel exposure machine (manufactured by Ore manufacturing Co., Ltd., Product Number: EXM-1172B-00), so as to obtain a double-sided adhesive sheet.

Here, with respect to the measurement of the moisture content, the substrate, the pressure sensitive adhesive sheet, and the conductive film laminate cut into predetermined rectangular shape and having predetermined areas and respective thicknesses were left in a high temperature and high humidity environment of the temperature of 25° C. and the humidity of 90% for one hour, and moisture contents (% by mass) were measured by Karl Fischer Moisture Titrate (manufactured by Kyoto Electronics Manufacturing Co., Ltd.: MKC610). The moisture contents and the total moisture content were obtained by converting the values by using the thickness.

Results thereof are shown in Table 1.

TABLE 1

| | | | | | | | | Pressure | |
|---|---|---|---|---|---|---|---|---|---|
| | | | | | | Pressure | Pressure | sensitive | |
| | | | | | | sensitive | sensitive | adhesive | |
| | | Pressure | | | Substrate | adhesive | adhesive | layer | Total |
| | | sensitive | Substrate | Substrate | moisture | layer | layer | moisture | moisture |
| | | adhesive | moisture | thickness | content | moisture | thickness | content | content |
| | Substrate | layer | content | (μm) | (g/m²) | content | (μm) | (g/m²) | (g/m²) |
| Example 1 | ZEONOR 40 μ | MGSFX | 0.01% | 40 | 0.004 | 0.53% | 100 | 0.526 | 0.53 |
| Example 2 | ZEONOR 40 μ | OS130927 | 0.01% | 40 | 0.004 | 0.31% | 100 | 0.315 | 0.319 |
| Example 3 | ARTON 40 μ | MGSFX | 0.15% | 40 | 0.059 | 0.53% | 100 | 0.526 | 0.585 |
| Comparative | ARTON 40 μ | 8146 | 0.15% | 40 | 0.059 | 1.26% | 100 | 1.259 | 1.318 |
| Example 1 | | | | | | | | | |
| Comparative | PET 100 μ | 8146 | 0.44% | 100 | 0.441 | 1.26% | 100 | 1.259 | 1.7 |
| Example 2 | | | | | | | | | |
| Comparative | ZEONOR 40 μ | 8146 | 0.01% | 40 | 0.004 | 1.26% | 100 | 1.259 | 1.263 |
| Example 3 | | | | | | | | | |

With respect to Examples 1 to 3 and Comparative Examples 1 to 3, electrostatic capacitance values (Cm values) of the conductive film laminates cut into a predetermined rectangular shape were measured in advance and obtained as initial values. Results thereof are shown in the column “0 day” in Table 2.

The conductive film laminates of which the electrostatic capacitance values were measured in advance, were left in a high temperature and high humidity environment of the temperature of 85° C. and the humidity of 85%, the electrostatic capacitance values (Cm values) of the conductive film laminates were measured again, after three days, seven days, and fourteen days elapsed, respectively. Results thereof are shown in Table 2.

Differences between the electrostatic capacitance values of the conductive film laminates after three days, seven days, and fourteen days elapsed and the initial values thereof were obtained, and the ratios (percentages) of the differences thereof to the initial values were obtained as change ratios of the electrostatic capacitance values of the conductive film laminates. Results thereof were shown in Table 2.

The electrostatic capacitance value was obtained by measuring a portion between the first detection electrodes 26 which are formed on the first conductive layer 14a and the second detection electrodes 30 formed on the second conductive layer 14b of the conductive film laminate by an LCR meter (4284A: manufactured by Murata MFG. Co., Ltd.).

TABLE 2

| | | Pressure | | | | | | | | |
|---|---|---|---|---|---|---|---|---|---|---|
| | | sensitive | Electrostatic capacitance | | | | Electrostatic capacitance | | | |
| | | adhesive | value (pF) | | | | value change ratio (%) | | | |
| | Substrate | layer | 0 day | 3 days | 7 days | 14 days | 0 day | 3 days | 7 days | 14 days |
| Example 1 | ZEONOR 40 μ | MGSFX | 938 | 990 | 990 | 977 | 0 | 5.54 | 5.54 | 4.16 |
| Example 2 | ZEONOR 40 μ | OS130927 | 940 | 977 | 964 | 967 | 0 | 3.94 | 2.55 | 2.87 |
| Example 3 | ARTON 40 μ | MGSFX | 1002 | 1079 | 1070 | 1063 | 0 | 7.68 | 6.79 | 6.09 |
| Comparative | ARTON 40 μ | 8146 | 1325 | 1443 | 1443 | 1441 | 0 | 8.91 | 8.91 | 8.75 |
| Example 1 | | | | | | | | | | |
| Comparative | PET 100 μ | 8146 | 1103 | 1193 | 1196 | 1190 | 0 | 8.16 | 8.43 | 7.89 |
| Example 2 | | | | | | | | | | |
| Comparative | ZEONOR 40 μ | 8146 | 1265 | 1366 | 1362 | 1360 | 0 | 7.98 | 7.67 | 7.51 |
| Example 3 | | | | | | | | | | |

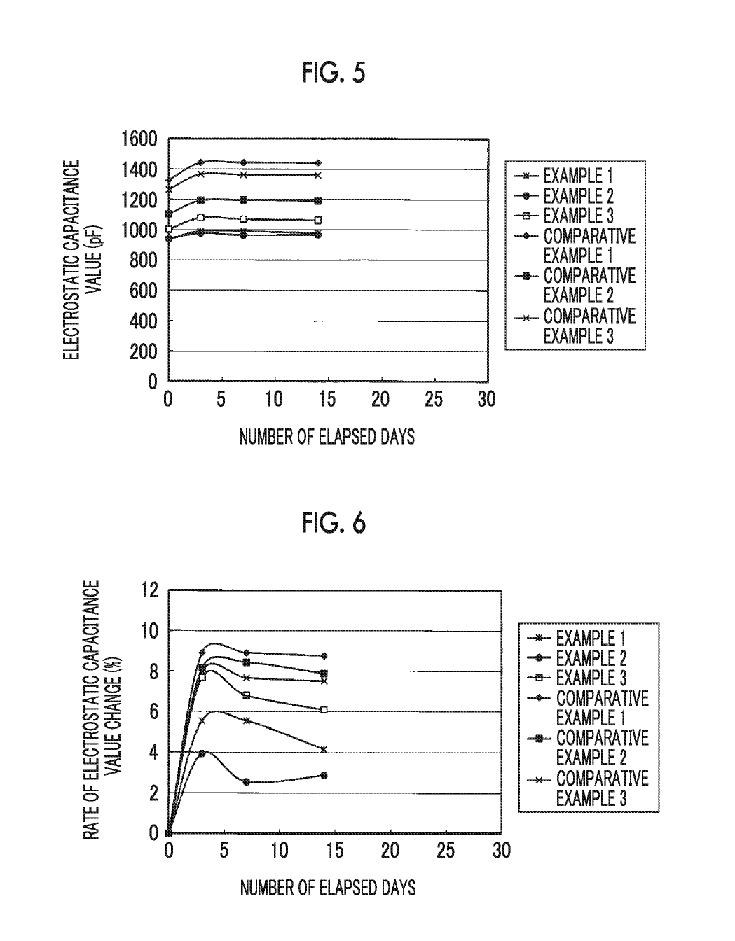

With respect to Examples 1 to 3 and Comparative Examples 1 to 3, graphs showing relationships of the electrostatic capacitance values of the conductive film laminates and the change ratios thereof with the number of elapsed days shown in Table 2 are illustrated in FIGS. 5 and 6.

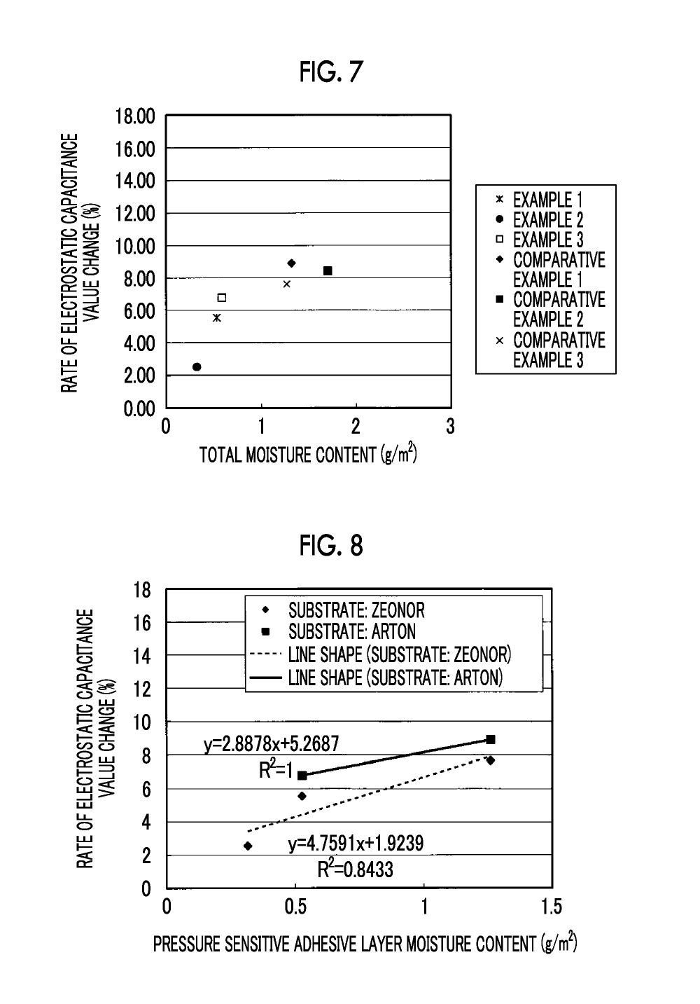

With respect to the conductive film laminates of Examples 1 to 3 and Comparative Examples 1 to 3, relationships of the change ratios of the electrostatic capacitance values after seven days elapsed shown in Table 2 and the total moisture contents shown in Table 1 are illustrated in FIG. 7 in graph.

With respect to the conductive film laminates in five examples of Examples 1 to 3 and Comparative Examples 1 and 3, change ratios of the electrostatic capacitance values of the conductive film laminates with respect to the moisture contents of the pressure sensitive adhesive layers (pressure sensitive adhesive sheets) are plotted on xy coordinates illustrated in FIG. 8. With respect to two types of substrates used in the conductive film laminates of the five examples, a graph showing a regression formula showing linearity between the moisture contents and the change ratios of the electrostatic capacitance values is illustrated in FIG. 8.

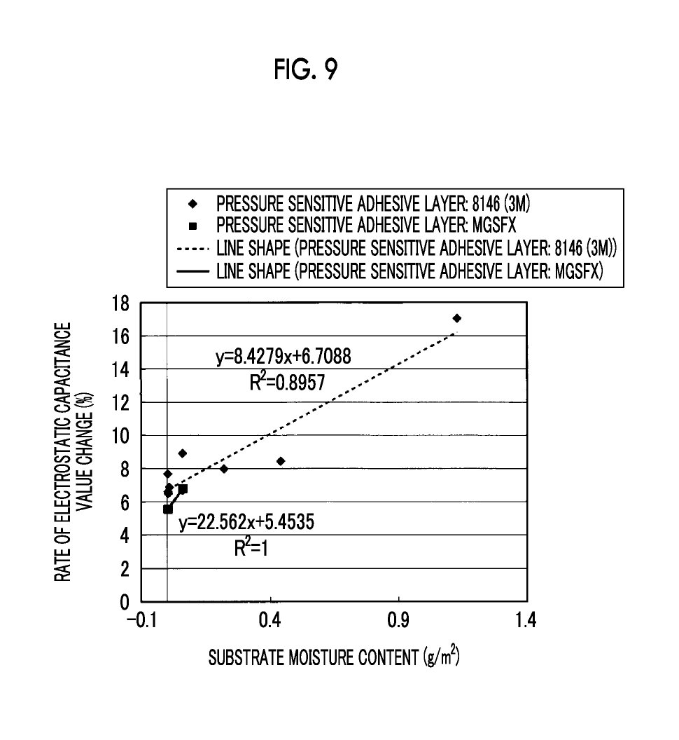

With respect to the conductive film laminates of eleven examples including Examples 1 and 3 and Comparative Examples 1 to 3, change ratios of the electrostatic capacitance values of the conductive film laminates to the moisture contents of the substrates are plotted on an xy coordinates illustrated in FIG. 9, and with respect to the two types of substrates used in the conductive film laminates of eleven examples, a graph showing a regyession formula showing linearity of moisture contents and the change ratios of the electrostatic capacitance values is illustrated in FIG. 9.

As shown in Tables 1 and 2 and FIG. 5, in Examples 1 to 3 in which the total moisture contents are 1 g/m² or less, the change ratios of the electrostatic capacitance values after seven days were 6.79% or less, the changes of the electrostatic capacitance values were small, there is less concern that malfunction as a touch panel occurs. Meanwhile, in Comparative Examples 1 to 3, the total moisture contents are greater than 1 g/m², the change ratios of the electrostatic capacitance values after seven days are 7.67% or greater, the change ratios of the electrostatic capacitance values are great, and there is more concern that malfunction occurs. These are the same with respect to the change ratios of the electrostatic capacitance values after three days and fourteen days.

As clearly understood from Tables 1 and 2 and FIGS. 8 and 9, if the change ratios of the electrostatic capacitance values of the conductive film laminate to the moisture amounts of the pressure sensitive adhesive layers (pressure sensitive adhesive sheets) and the substrates are compared by the same moisture contents, the change ratios of the electrostatic capacitance values of the conductive film laminates to the moisture amounts of the substrate are greater than those of the pressure sensitive adhesive layers (pressure sensitive adhesive sheets). Inclinations of two regression formulae of change ratios of the electrostatic capacitance values of the conductive film laminates to the moisture amounts of the pressure sensitive adhesive layers (pressure sensitive adhesive sheets), with respect to the two types of substrates, illustrated in FIG. 8 are 2.89 and 4.76. Meanwhile, inclinations of two regression formulae of change ratios of the electrostatic capacitance values of the conductive film laminates to the moisture amounts of the substrates, with respect to the two types of the pressure sensitive adhesive layers, illustrated in FIG. 9 are 8.43 and 22.5. Therefore, it is understood that a moisture amount of a substrate influences on an electrostatic capacitance change more than a moisture amount of a pressure sensitive adhesive layer (pressure sensitive adhesive sheet).

Therefore, according to the invention, it is preferable to lower a moisture amount of a substrate of which both surfaces are interposed between first and second conductive layers (detection electrodes) than a moisture amount of a pressure sensitive adhesive layer (pressure sensitive adhesive sheet).

As clearly shown from Tables 1 and 2 and FIG. 9, it is understood that, if a moisture content of a substrate is 0.06 g/m² or less, even if any pressure sensitive adhesives are used, a change ratio of electrostatic capacitance values becomes 7% or less.

As clearly shown from Tables 1 and 2 and FIG. 8, it is understood that, if the moisture amount of the pressure sensitive adhesive layer (adhesive sheet) is 0.53 g/m² or less, even if any substrates are used, a change ratio of electrostatic capacitance values become 7% or less.

From the above, the effects of the invention are clear.

### EXPLANATION OF REFERENCES

10: conductive film laminate

12: substrate

14a,14b: conductive layer

16a,16b: pressure sensitive adhesive layer (pressure sensitive adhesive sheet)

18: electrostatic capacitance-type touch panel sensor

22: protective substrate

24: display device

26, 30: detection electrode

28, 32: lead-out wiring

34: flexible printed wiring board

36: conductive thin wire

38: lattice

E0: external side area

E1: input area (detection area)

P: pitch

What is claimed is:

1. A conductive film laminate that is used in a touch panel, comprising:
a first pressure sensitive adhesive layer;
a first conductive layer;
a substrate;
a second conductive layer; and
a second pressure sensitive adhesive layer, in this order,
wherein a total moisture content of the substrate, the first pressure sensitive adhesive layer, and the second pressure sensitive adhesive layer is 1.0 g/m² or less.

2. The conductive film laminate according to claim 1,
wherein a moisture content of the substrate is less than a total moisture content of the first pressure sensitive adhesive layer and the second pressure sensitive adhesive layer.

3. The conductive film laminate according to claim 1,
wherein a moisture content of the substrate is 0.06 g/m² or less.

4. The conductive film laminate according to claim 1,
wherein a total moisture content of the first pressure sensitive adhesive layer and the second pressure sensitive adhesive layer is 0.53 g/m² or less.

5. The conductive film laminate according to claim 1,
wherein a thickness of the substrate is 50 μm or less.

6. The conductive film laminate according to claim 1,
wherein in-plane retardation of the substrate at a wavelength of 550 nm is 200 nm or less.

7. The conductive film laminate according to claim 1,
wherein the substrate is a λ/4 wavelength plate.

8. The conductive film laminate according to claim 1,
wherein the first conductive layer and the second conductive layer are constituted by mesh-shaped metal thin wires.

9. A touch panel using the conductive film laminate according to claim 1.

10. The touch panel according to claim 9,
wherein the touch panel is an electrostatic capacitance-type touch panel.
